(19) United States
(12) Patent Application Publication
(10) Pub. No.: US 2020/0353617 A1
(43) Pub. Date: Nov. 12, 2020

(54) METHOD OF CONTROL OF BRAKE DEVICES IN A ROBOT SYSTEM AND ROBOT

(71) Applicant: FRANKA EMIKA GmbH, Munich (DE)

(72) Inventors: Andreas SPENNINGER, Karlsfeld (DE); Dmitrij FORSSILOW, Munich (DE)

(21) Appl. No.: 16/870,267

(22) Filed: May 8, 2020

(30) Foreign Application Priority Data
May 8, 2019 (DE) 10 2019 112 029.2

(51) Int. Cl. B25J 9/16; F16D 63/00; F16D 65/16; F16D 66/00

(52) U.S. Cl. CPC B25J 9/1628; F16D 63/006; F16D 2121/24; F16D 66/00; F16D 65/16

(57) ABSTRACT

A method for controlling a braking device for a drive unit of a joint between two members of a multi-axis robot arm of an articulated arm robot including a brake activation device and a locking element, wherein the drive unit includes a rotor with at least two radial brake elements and the brake activation device is formed, bringing the locking element into engagement with a brake element when required in order to stop rotation of the rotor, wherein a detected position of at least one brake element is compared with a stored absolute position with respect to this brake element.

### FIELD OF THE INVENTION

The present invention relates to methods for controlling a braking device for a drive unit of a joint between two members of a multi-axis robot arm of an articulated arm robot and corresponding robot systems.

### BACKGROUND OF THE INVENTION

In particular for robots for use in the field of human-robot collaboration (HRC) it is mandatory to provide for safety reasons an emergency stop or braking device in case of malfunction or sudden failure of the power supply, which is designed to stop the robot arm as quickly as possible in order to prevent injuries to an operator of the robot system or to prevent the object manipulated by the robot arm in the course of the activity to be performed by the robot arm or the robot arm itself from being damaged. Such an emergency stop can also be caused directly by the user, for example by pressing an emergency switch.

For example, braking devices are known for articulated arm robots in a wide variety of designs, with the aid of which the movement of the robot arm can be brought to an abrupt stop, at least to a very rapid stop within a defined period of time.

European Patent No. 3 045 273 discloses a braking mechanism in which a friction ring is mounted coaxially with the motor shaft, with which a pin of a locking device cooperates by engaging the pin radially in the friction ring in an emergency. Due to the fact that the friction ring is rotatable relative to the motor shaft under a defined frictional engagement, a slight braking delay of the rotational movement is realized when the radial pin engages.

The German patent application No. 10 2015 116 609 A1 reveals a braking device in which a brake star is non-rotatably arranged on the motor shaft of the drive unit, which has six radially protruding teeth arranged equidistantly in the circumferential direction. A brake activation device is provided coaxially to the axis of the motor shaft, which forces a locking pin into the rotational range of the brake star when required, e.g. during emergency braking, so that one tooth of the brake star comes into engagement with the locking pin. Such a braking device can also be designed to lock each joint of a multi-axis robot arm in the respective position when the robot is at a standstill.

If the absolute positions of the teeth in relation to the motor shaft are known and stored in a corresponding memory, the respective positions of the teeth can also be determined in principle by means of a rotary encoder, which detects the current angular position of the motor shaft, and by means of a correspondingly developed controller.

The absolute positions of the teeth, once determined, do not change as long as the relative position of the brake star in relation to the motor shaft or the rotor does not change, e.g. slips due to friction, as is the case with state-of-the-art technology. For these reasons, it is intended that the brake star is connected to the rotor so that it cannot rotate, e.g. by adhesive bonding.

Nevertheless, it is possible that corresponding faults may occur in such a generic braking device, which may require an emergency stop or even a complete stoppage of the robot. In this case, it may occur that the absolute position of at least one tooth of the brake star has changed over time or abruptly. Deviations in relation to the current position can occur during operation of the robot system, for example, if the tooth and/or the locking bolt have been plastically deformed and/or the brake star has shifted in relation to the rotor contrary to expectations. In order to ensure the functional reliability of the robot system and in particular of the braking devices of the joints, it is therefore absolutely essential to recognize or detect such deviations in good time.

### SUMMARY

Starting from this, it is an objective of the invention to provide a method for controlling a braking device for a drive unit of a joint between two members of a multi-axis robot arm of an articulated arm robot, by means of which the said faults can be detected in a simple manner.

This objective is solved according to the invention by a method for controlling a braking device for a drive unit of a joint between two members of a multi-axis robot arm of an articulated arm robot according to claim 1.

Accordingly, the invention relates to a method of controlling a braking device for a drive unit of a joint between two members of a multi-axis robot arm of an articulated arm robot comprising a brake activation device and a locking element, wherein the drive unit comprises a rotor with at least two radial brake elements, each enclosing a free circumferential segment therebetween in the circumferential direction, and wherein the brake activation device is adapted to bring the locking element into engagement with a brake element when required to stop rotation of the rotor, the method comprising the steps of
actuating the locking element;
rotating the brake elements or the rotor, respectively, until a first brake element comes to rest against the locking element under a defined torque;
detecting the position of the blocked first brake element; and
comparing the detected position with a stored absolute position of the first brake element.

Preferably, the locking element is designed as a bolt which can engage with a brake star, which has at least two tooth-like, radially protruding brake elements, or with these brake elements.

If the brake bolt and/or a brake element is/are plastically deformed, at least one position detected by means of the method according to the invention is faulty or deviates from the respective stored value in relation to the brake element.

In a further embodiment of the method according to the invention, the method comprises the further steps:
releasing of the locking element;
rotating the rotor until a second brake element comes to rest against the locking element under a defined torque;
detecting the position of the blocked second brake element; and
comparing of the detected position with stored absolute positions of the second brake element.

The brake star may have several equidistantly arranged brake elements, so that according to the invention it may be provided that the aforementioned steps are repeated according to the number of brake elements present. In principle, these steps can only be carried out in one direction of rotation or successively in both directions of rotation.

By checking all positions according to the number of brake elements present, it can be determined whether the brake star, which should actually be connected to the rotor in a rotationally fixed manner, has rotated for any reason relative to the rotor without any deformations actually occurring on the brake elements and/or the brake bolt.

To provide additional control steps, it may also be provided that the torque is varied when the locking element is applied or attached to the brake element(s). Different torques or speeds of rotation make it possible, for example, to check whether the brake star only begins to move once a certain torque has been applied, because, for example, the bond between the brake star and the motor shaft is beginning to disintegrate. In addition, it may be provided that the rotor or the brake star is rotated by at least one segment width of the circumferential segment or by a total of 360°. This makes it possible to reliably detect that a deformed brake bolt is present, since it is more likely in such a case than with a deformed brake star that a circumferential segment can no longer be released because the locking bolt is jammed.

Preferably, the described steps of the method are performed individually for each joint of a multi-axis articulated arm robot.

If positional deviations can be determined by means of the method according to the invention, which is equivalent to a malfunction of the braking device or even a failure of the braking device or components thereof, it is then provided according to the invention that at least the braking device concerned is blocked and/or the entire articulated arm robot is shutdown.

The position deviations are compared with a previously defined and stored threshold value. Only if this threshold value is exceeded will the robot be put to a stop. The level of the threshold value or a threshold value range takes into account the resolutions of the encoder for measuring the angular position of the rotor, possible measurement inaccuracies, non-linearities or material-related flexibility and elasticity of individual components, so that misinterpretations do not occur.

A controller of the robot system or at least of the joint can have corresponding evaluation algorithms for this.

Ideally, the above mentioned steps of the method according to the invention are carried out successively for a first joint of the multi-axis robot arm, and if the position determination is successful without detected deviations with respect to this first joint, these steps of the method are carried out for a second joint following the first joint. In a preferred embodiment of this method, these steps are performed consecutively in one of the two sequences of the joints of the multi-axis robot arm for each joint individually, i.e. in the order of the axes. In other words, all the braking devices of the individual joints of the robot arm are checked from its one end, e.g. the distal end carrying an effector, to its other end, e.g. the stationary base, or vice versa, and the respective actual positions of the brake elements and/or the brake star are thus “measured”.

The invention further relates to a computer program, comprising program instructions which cause a processor to execute and/or control the steps of the described method when the computer program is running on the processor, as well as a data carrier device related thereto. The invention also relates to a computer system with a data processing device, wherein the data processing device is designed such that the described method is executed on the data processing device.

Furthermore, the invention also relates to a robot system with a multi-axis robot arm having means for carrying out the described method.

As mentioned, the step of detecting the actual position of the at least one brake element comprises determining, preferably calculating, this position from stored absolute positions with respect to this at least one brake element in relation to an absolute position of the rotor or motor shaft detected by means of an encoder and thus to the absolute position of the locking element arranged stationary relative to the motor shaft.

Before carrying out this step, it may therefore be necessary to determine or detect the absolute positions of at least one brake element of the brake star, preferably of all brake elements, in relation to the rotor and thus to the motor position.

This can be done physically by sampling corresponding values by means of corresponding rotary encoders, rotary position sensors and the like, which interact with the respective elements in a corresponding manner, e.g. by means of Hall elements known per se; preferably, however, according to the invention, these positions are to be determined, i.e. preferably calculated, by means of a correspondingly distinct control logic.

In this way, there is no need to use additional sensors and to install them at suitable positions within the braking device. The installation space for the braking device and thus the drive unit need not be unnecessarily restricted by this.

The determination of the positions as such has in itself an independent inventive step. For these reasons, the present invention relates in a further aspect to a method, separately or combined with the method described above, for controlling a braking device for a drive unit of a joint between two members of a multi-axis robot arm of an articulated arm robot comprising a brake activation device and a locking element, wherein said drive means comprises a rotor having at least two radial brake elements each circumferentially enclosing a free circumferential segment therebetween, and wherein said brake activation device is adapted to bring said locking element into engagement with a brake element as required to stop rotation of said rotor, said method comprising the steps of
actuating the locking element;
rotating the brake elements until a first brake element comes to rest against the locking element under a defined torque;
sensing the position of the blocked first brake element;
releasing the locking element;
rotating the brake elements until a second brake element comes to rest against the locking element under a defined torque;
detecting the position of the blocked second brake element; and
defining of the detected positions as absolute positions of the brake elements in relation to an absolute position of the rotor, which is preferably measured and reflects the motor position.

Ideally, these steps are carried out immediately after completion of the assembly of such a robot arm and during start-up of operation. In other words, the motor of the drive unit drives the rotor with the brake star and is controlled against the bolt that is in a locked position, applying a sufficiently high current to ensure that the bolt is always in contact with a radial brake element of the brake star. The bolt is then released and the brake star is moved by the respective distance (i.e. short or long distance) within the circumferential segment in which the bolt initially lies.

In a further embodiment of the method, the torque when the locking element is applied to the brake element can be varied to ensure that it is actually fully applied.

By means of this method according to the invention, it is possible to “measure” the brake star as it were. It is therefore not necessary to manufacture it with high tolerances. Any deformations occurring during installation of the brake star have no influence.

The absolute positions obtained in this way are preferably stored in a memory assigned to the joint in the drive unit. This has the advantage that when a drive unit is removed and subsequently installed, the position data once determined need not be recorded again. In this respect, the braking device therefore no longer needs to be calibrated unless maintenance or repair work had to be carried out directly on it or components of it had to be replaced. The relevant data can, however, also be stored in a master controller of the robot system, in particular in addition.

The above-mentioned steps must therefore be repeated exactly twice as often as the number of brake elements equidistantly arranged on the rotor, since each brake element can come into contact with the bolt from both sides, depending on the direction of rotation. Consequently, these steps can be carried out in one direction of rotation, or one after the other in both directions of rotation, individually for each joint of a multi-axis articulated arm robot.

### BRIEF DESCRIPTION OF THE FIGURES

Further advantages and features of the present invention result from the description of the embodiment shown in the enclosed drawings.

FIG. 1 is an example of a perspective view of a braking device according to the invention;

FIG. 2 is a schematic representation of the segments of a brake star and the positions of the individual elements in relation thereto;

FIG. 3 is a schematic representation of the segments at an angular offset of the brake star; and

FIG. 4 exemplary illustrates a flow chart of the method according to the invention.

### DETAILED DESCRIPTION

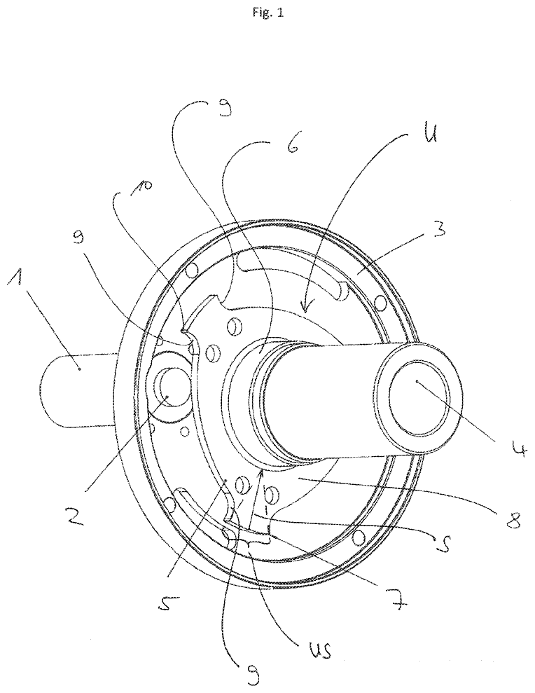

The braking device shown schematically in FIG. 1 according to the invention can preferably be attached to the front face of one end of a drive unit of a joint between two members of a robot arm, preferably in a joint unit as described in German patent application No. 10 2016 004 787.9.

The braking device according to the invention comprises a brake activation device 1, which may be a magnet-activated holding or spring mechanism, for example. The brake activation device 1 is conceived and designed to activate a locking element in the form of a bolt 2 when required, e.g. in the event of an unexpected power failure, whereby the bolt 2 is then driven upwards, e.g. by a spring.

By means of a bearing disk 3, which is fixed to the housing, i.e. connected to a not shown housing of the drive unit, a motor shaft or a rotor 4 of the drive unit can be supported by known bearings (not shown). The brake activation device 1 with the bolt 2 is arranged stationary on the bearing disk 3.

The rotor 4 carries a brake element in the form of a brake star 5, which is connected, e.g. glued, to the rotor 4 in a rotationally fixed manner via an axially extending sleeve 6.

The brake star 5 has three webs 7 spaced at an equal circumferential angle to each other, which extend radially from an inner ring 8 of the brake star 5.

By means of the preferably solenoid-operated brake activation device 1, bolt 2 can be moved between a locked position, which it occupies without energy supply, and a release position occupied when energy is supplied. FIG. 1 shows bolt 2 in such a release position; this bolt 2 is located axially below the rotating brake star 5, thus out of engagement with one of the webs 7. When the energy is switched off, the bolt is forced towards the brake star 5 by the spring force of a spring, which is then released by a magnet which is no longer activated, and thus passes between two adjacent webs 7 of the rotating brake star 5, whereby an abrupt braking of the drive shaft or the rotor 4 is realized as soon as the next web 7 hits against the bolt 2.

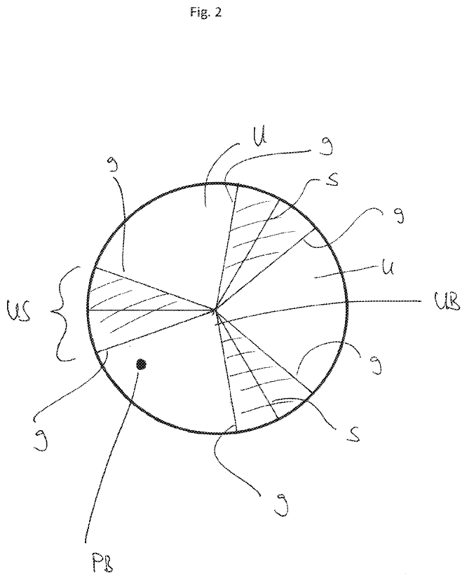

FIG. 2 schematically shows the segmentation of the brake star 5 with the relative positions of the individual webs 7 and bolt 2.

The webs 7 are arranged at an equal distance from each other, i.e. with three webs 7, their central radial axes S are 120° apart. Since the webs 7 themselves have a certain width due to their design, as shown in FIG. 1, e.g. a circumferential extension US of 40°, the edges 9 of the webs 7, against which the bolt 2 comes to rest, include free circumferential segments U with an angular extension of 80°.

Since the positions of the edges 9 on both sides of each web 7 in relation to the angular position of the rotor 4 and thus of the motor position have been determined in advance and stored, and since the absolute, since stationary position PB of bolt 2 is known, it is then possible in the following to determine where the individual positions of the edges 9 are located by detecting the angular position of the rotor 4 or of the motor shaft in the control system, and thus to determine that circumferential segment UB in which bolt 2 is actually located after braking or locking has been carried out.

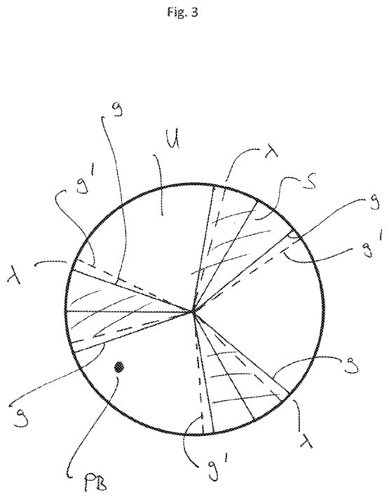

FIG. 3 shows schematically how the positions of the edges 9 have changed if the brake star 5 slips unintentionally in relation to the axis of the rotor 4. By moving the brake star 5, i.e. each brake element 7 towards the brake bolt 2, it is possible to detect, via corresponding algorithms implemented in the control system, that the edges 9′ of the individual webs 7 have shifted by an angle λ in one direction of rotation. This angle λ is compared with a stored threshold value λₘₐₓ for this angle λ and, if it is exceeded, the controller causes the joint relating to this braking device and therefore the entire robot to stop.

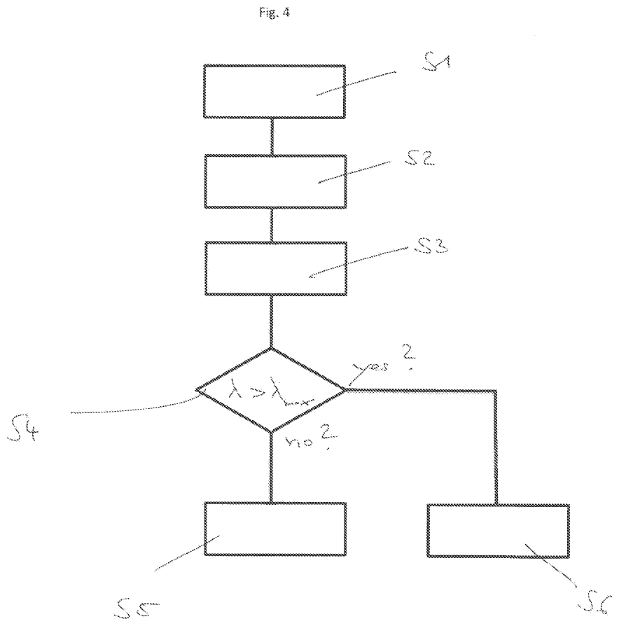

FIG. 4 schematically shows a flowchart with respect to the method according to the invention.

In a first step S1, locking bolt 2 is actuated so that in a subsequent step S2, when the brake star 2 is rotated, a first web 7 comes to rest against locking bolt 2 under a defined torque. Since the original position of the edge 9 of this web 7 coming into contact is known, it can be calculated in a further step S3 by means of the degree of rotation whether this original position of the edge 9 is maintained, taking into account certain tolerance ranges which influence the threshold value λₘₐₓ, or whether a deviation λ can be detected, i.e. a new position of the edge 9′ could be recorded.

In a comparison step S4 this deviation λ is compared with the threshold value λₘₐₓ. If it still moves in an area that indicates sufficient functionality of the braking device, the robot system is released for further operation in a step S5. However, if this threshold value λₘₐₓ is exceeded, according to the invention the robot is stopped in an alternative step S6.

Ideally, the steps described above are carried out individually, preferably consecutively from one end to the other end, for each joint of the multi-axis robot arm when a robot is activated, and then again preferably at fixed intervals over the period of use of the robot.

1. A method for controlling a braking device for a drive unit of a joint between two members of a multi-axis robot arm of an articulated arm robot comprising a brake activation device and a locking element, wherein the drive unit comprises a rotor with at least two radial brake elements, each enclosing a free circumferential segment therebetween in the circumferential direction, and wherein the brake activation device is adapted to bring the locking element into engagement with a brake element when required to stop rotation of the rotor, the method comprising the steps of:
actuating the locking element;
rotating the brake elements until a first brake element comes to rest against the locking element under a defined torque;
detecting the position of the blocked first brake element; and
comparing the detected position with a stored absolute position of the first brake element.

2. The method according to claim 1, comprising the further steps:
releasing the locking element;
rotating the rotor until a second brake element comes to rest against the locking element under a defined torque;
detecting the position of the blocked second brake element; and
comparing of the detected position with stored absolute positions of the second brake element.

3. The method according to claim 1, in which the torque is varied when the locking element is applied to the brake element(s).

4. The method according to claim 1, in which the rotor comprises a plurality of equidistantly arranged brake elements, comprising the step of:
repeating the steps according to the number of brake elements present.

5. The method according to claim 4, in which these steps are carried out in one direction of rotation; or
one after the other in both directions of rotation.

6. The method according to claim 1, in which the method is carried out individually for each joint of a multi-axis articulated arm robot.

7. The method according to claim 1, in which the braking device is blocked and/or the articulated arm robot is stopped if the detected position(s) deviates from the stored position(s) by a defined threshold value (λₘₐₓ).

8. A computer program comprising program instructions which cause a processor to execute and/or control the steps of the method according to any one of claim 1 when the computer program is running on the processor.

9. A data carrier device on which a computer program according to claim 8 is stored.

10. A computer system comprising a data processing apparatus, the data processing apparatus being arranged such that a method according to claim 1 is carried out on the data processing apparatus.

11. A robot system with a multi-axis robot arm comprising means for carrying out the method according to claim 1.

12. The method according to claim 2, in which the torque is varied when the locking element is applied to the brake element(s).

13. The method according to claim 2, in which the rotor comprises a plurality of equidistantly arranged brake elements, comprising the step of:
repeating the steps according to the number of brake elements present.

14. The method according to claim 3, in which the rotor comprises a plurality of equidistantly arranged brake elements, comprising the step of:
repeating the steps according to the number of brake elements present.

15. The method according to claim 13, in which these steps are carried out in one direction of rotation; or
one after the other in both directions of rotation.

16. The method according to claim 14, in which these steps are carried out in one direction of rotation; or
one after the other in both directions of rotation.
